(19) United States
(12) Patent Application Publication
(10) Pub. No.: US 2005/0240761 A1
(43) Pub. Date: Oct. 27, 2005

(54) Write control method and computer system

(76) Inventor: Kiyoto Yui, Tokyo (JP)

Correspondence Address: GREENBLUM & BERNSTEIN, P.L.C., 1950 ROLAND CLARKE PLACE, RESTON, VA, 20191, US

(21) Appl. No.: 10/524,629

(22) PCT Filed: Jul. 26, 2004
(86) PCT No.: PCT/JP04/10617

§ 371 Date: Feb. 16, 2005

(30) Foreign Application Priority Data
Jul. 31, 2003 (JP) 2002-283449

(51) Int. Cl. H04L 9/00

(52) U.S. Cl. 713/165

(57) ABSTRACT

To prevent securely writing of file by compute virus or unjust access, and protect the user from the thread of unjust file writing.

A computer system 1 comprising a control unit 11 for executing various control processes, storage device 37 for storing a file, with the control unit 11 executing writing of file into the storage device 37 by making use of file management system 33 by an OS 32 as basic software, a key switch 25 for controlling changeover of write permission or rejection to the storage device 37 on the basis of changeover input by a user, and write control software 34, in which the file management system 33 is set to transmit to the storage device 37 by way of the write control software 34 when transmitting the write command to the storage device 37.

### TECHNICAL FIELD

The present invention relates to a write control method for controlling write permission or rejection when writing a file into, for example, storage means, and a computer system.

### BACKGROUND ART

In a computer system, hitherto, a file of program or data is stored in a hard disk drive or other storage device, and the file is read or written and used in various information processes.

At the present, along with the wide spread of the Internet, most computer systems of corporate or personal use are connected to the network, and data is transmitted and received mutually.

In this background, however, there are various problems such as unjust access to the computer system from outside by ill-willed user of the network to alter the file unknowingly.

Further, ill-willed programs (executable file) called computer viruses are written into the storage device of computer system unknowingly, and these problems are causing serious social problems (see non-patent references 1, 2).

If the file is written by such computer virus or unjust access, it is not possible to distinguish perfectly whether such writing is normal writing or unjust writing, which is a radical problem.

Non-patent reference 1: Neil Matthew & Richard Stones: Linux Programming.

Non-patent reference 2: Interface, December 2002, CQ Publication.

### DISCLOSURE OF THE INVENTION

### PROBLEMS TO BE SOLVED BY THE INVENTION

The invention proposes a write control method and computer system capable of preventing securely writing of file by computer virus or unjust access, and is intended to protect the user from the thread of unjust file writing.

### MEANS TO SOLVE THE PROBLEMS

The invention is a write control method or computer system for controlling writing of file into storage means by making use of file management system by an operation system as basic software of computer system, by control means for executing various control processes in a computer system, being a write control method or computer system in which write control means changes over permission or rejection of writing into the storage means on the basis of changeover input by a user, and transmits to the storage means by way of the write control means when transmitting a write command to the storage means in the file management system.

The storage means is composed of hard disk, recording medium, drive device for writing into the recording medium, volatile memory, nonvolatile memory, or a plurality thereof, and means for storing the file programmably.

The write control means includes a changeover unit for allowing changeover input, and a write control operation execution unit for executing either operation of write permission or write rejection by judging permission or rejection of writing on the basis of the changeover input. The changeover input unit is composed of electronic switch by physical means such as key or pushbutton, or software switch for changing over on the software.

In this configuration, the user can change over permission or rejection of writing. Thus, file writing by unjust access or computer virus can be prevented by rejecting writing.

In one aspect of the invention, the write control means is provided with a switch, and permission or rejection of writing can be physically changed over by this switch.

Since permission or rejection of writing can be physically changed over, alteration of setting of permission or rejection of writing by ill-willed access to the computer system can be prevented.

In an aspect of the invention, when permitting writing by the write control means, the write command is passed, and when rejecting writing, the write command is blocked.

Thus, the permitted write command can be executed as usual, and the rejected write command cannot be executed.

In an aspect of the invention, the write control means rejects writing when the user has changed over to reject writing by input of changeover and the file of write command is a file of write rejected type, and permits writing otherwise.

The file of write rejected type includes executable file and other file having effects on the system.

In this configuration, write permission or rejection can be judged depending on the file type. Therefore, by controlling write permission or rejection about the file having effects on the system, and by permitting to write without write control as for the file not having effects on the system, the utility of computer system is enhanced.

In an aspect of the invention, the write control means rejects writing when the user has changed over to reject writing by input of changeover and the folder holding the file according to the write command has been set in write rejection, and permits writing otherwise.

As a result, write permission or rejection can be judged depending on whether the file writing destination is prohibited folder or not. Therefore, by controlling write permission or rejection about the file having effects on the system, and by permitting to write without write control as for the file not having effects on the system, the utility of computer system is enhanced.

The invention also presents a write control program for executing the above write control method.

By incorporating a write control program, a computer system executing the write control method can be easily built up.

The invention further presents an operating system incorporating the above write control program.

Thus, the write control can be realized by the operating system (OS) of the basic software of the computer system.

### ADVANTAGE OF THE INVENTION

The invention can securely prevent writing into file by computer virus or unjust access.

### BEST MODE FOR CARRYING OUT THE INVENTION

An embodiment of the invention is described below while referring to the accompanying drawing.

An outline configuration of computer system 1 is explained by referring to a perspective view in FIG. 1 (A) and a front partial magnified view in (B).

The computer system 1 comprises a casing 10, a display 21, and mouse and keyboard not shown.

The front panel of the casing 10 has a keyhole 25a for a key switch 25. By inserting a key 26 into the keyhole 25a and turning, write permission or rejection into the storage device can be changed over.

In this configuration, the user can insert the key 26 into the keyhole 25a and turn. As a result, write permission or rejection into the storage device can be changed over by physical operation.

The configuration of the computer system 1 is explained together with the block diagram in FIG. 2.

The computer system 1 is connected to a bus 20, and comprises control unit 11, keyboard 12, mouse 13, FD drive 14, CD-ROM drive 15, USB interface 16, display 21, communication unit 22, hard disk 23, and key switch 25.

The control unit 11 is composed of CPU, ROM, and RAM, and executes various control processes. The control processes include the process conforming to the OS (the operating system of the basic control software), and the process conforming to the file management system as part of the functions of the OS.

The keyboard 12 sends an input signal by key input to the control unit 11. The mouse 13 sends entered coordinate signal and click signal to the control unit 11.

The FD drive 14 executes process of writing or reading of file according to the control of the control unit 11.

The CD-ROM drive 15 executes process of reading of file or the like according to the control of the control unit 11.

The USB interface 16 is an interface for connecting the printer, scanner, digital camera or other USB devices. According to the control of the control unit 11, signals are transmitted and received with the connected USB devices, and operation control of USB devices is executed.

The display 21 displays characters, patterns and other images according to the control of the control unit 11.

The communication unit 22 is LAN card or other device for communicating by connecting to the network. It communicates with other connected device on the network according to the control of the control unit 11.

The hard disk 23 executes file writing or reading process according to the control of the control unit 11.

The key switch 25 is an electronic switch (hardware switch) which is turned on or off by turning the key 26 inserted in the keyhole 25a (FIG. 1). By turning on or off by the key 26, the ON signal or OFF signal is sent to the control unit 11. The key switch 25 functions as write prohibit mechanism, and either one of ON signal and OFF signal is write permit signal (prohibit mechanism is invalidated) and other is write reject signal (prohibit mechanism is validated).

In this configuration, the control unit 11 controls various operations of the computer system 1. In the case of access to the hard disk 23 or access to the flexible disk (FD) by the FD drive 14, it conforms to the write permission or rejection control by the key switch 25.

Referring now to the conceptual diagram of FIG. 3, the configuration of the software about writing into the storage device is explained.

Writing into the storage device 37 is controlled by application 31, OS 32, file management system 33, and write control software 34.

The storage device 34 is composed of hard disk 23, FD drive 14 incorporating flexible disk, and RAM in the control unit 11.

The application 31 is an arbitrary user program operating on the computer system 1, and it is a program operating on the OS 32. As part of the function, a command of reading or writing of file is executed on the OS 32. Herein, the write command includes three instructions, that is, Create for creating a new file, Open for opening the file, and Attribute change for changing the attribute of stored file. In addition, Delete instruction for detecting the file is also present as one of write commands.

For example, Copy command is a compound command of Read and Create of file, and such compound command is also processed in the unit of basic command (Create, Open, Attribute change, Delete).

The OS 32 receives a write command from the application 31, and sends to the write control software 34 by way of the file management system 33. Other processes than file read or write command are executed directly on the storage device 37.

The write command includes the file name and save destination (including the designation of storage device, such as hard disk 23, flexible disk 14, or RAM in the control unit 11), and specifies to write into which storage device.

The write control software 34 is located at a lower layer beneath the file management system 33, and judges if the key switch 25 is turned on or off. In the case of write permit (write valid), the write command from the file management system 33 is passed, and writing is permitted. In the case of write reject (write prohibit), the write command from the file management system 33 is blocked, and writing is prohibited.

In this embodiment, writing is permitted when the key switch 25 is turned on, and rejected when turned off.

In this configuration, according to the write command sent from the application 31 by way of the OS 32, writing or not into the storage device 37 can be controlled by the key switch 25.

Together with the processing flow chart shown in FIG. 4, the entire process of the file management process by the computer system 1 is explained.

The OS 32 transfers the file process request from the application 31 to the write control software 34 by way of the file management system (step n1).

The write control software 34 judges if the received file process request is create request or not (step n2), and in the case of create request, write control process for create is executed (step n3), and the process is terminated.

If it is not create request at step n2, it is judged whether it is open request or not (step n4), and in the case of open request, write control process for open is executed (step n5), and the process is terminated.

If it is not open request at step n4, it is judged whether it is attribute change request or not (step n6), and in the case of attribute change request, write control process for attribute change is executed (step n7), and the process is terminated.

If it is not attribute change request at step n6, it is judged whether it is delete request or not (step n8), and in the case of delete request, write control process for delete is executed (step n9), and the process is terminated.

If it is not delete request at step n8, it is judged that the file process request is not write command. Therefore, the write control software 34 allows to pass the file process request directly and sends to the storage device 37. The storage device 37 executes the process according to this file request process (step n10), and the process is terminated. In this case, the file request process is a process not accompanied by writing into the storage device 37, such as read request.

By this operation, the file process request is judged to be any of create, open, attribute change, delete or other request, and the corresponding process can be executed.

Depending on the structure of the OS 32, each file process may be executed directly by specifying the function number assigned preliminarily, or memory address for storing the program for processing.

In this case, the application 31 may directly call and execute the steps n3, n5, n7, n9, n10 for composing the write control software 34. Therefore, omitting the judging process at steps n2, n4, n6, n8 shown in FIG. 4, steps n3, n5, n7, n9, n10 are directly executed.

Referring next to the process flow in FIG. 5, the write control process for create executed by the control unit 11 according to the write control software 34 is explained.

When the prohibit mechanism is valid, that is, when the key switch 25 is set at the write reject side (step p1), it is judged whether the write command object file is executable or not (step p2).

The method of judging whether executable or not varies with the type of the OS 32. For example, it may be judged to be executable when the file name is followed by the extension such as .exe, .com, .cmd, .bat or .dll.

In the case of the OS 32 setting up an attribute flag for permitting to execute the file, it may be judged to be executable when the attribute flag is set up.

Or else, in the case of the specification uniquely determined to be executable by the specification of the OS 32, the executable type is judged according to the specification of the OS 32.

Thus, in the case of judging an executable file, it is an extraordinary process, and create process is not executed, and an error is set (step p3). Instead of setting an error, the execution attribute may be turned off, and it may be created as nonexecutable attribute. Or saving position of file name or file may be changed at will. Thus, at step p3, any other process than the request from the application 31 and OS 32 can be executed freely.

At step p2, when the file is not executable, it is judged whether the write destination is prohibited folder or not (step p4). The prohibited folder is a folder setting to prohibit writing, which is presented by the function of the OS 32.

More specifically, in the case of the OS called Linux, other folders than /home, /var, and /tmp can be set as prohibited folders. Thus by specifying the folders having effects on the system as prohibited folders, a stable system can be built up.

Whether prohibited folder or not is judged in consideration of setting of write prohibit about the folder of file write destination, and also setting of write prohibit of folder of upper layer of this folder. That is, if the upper layer folder is a prohibited folder, all other folders in lower layers are handled as prohibited folders.

For setting writing permission of the folder of the upper layer belong to, an attribute table corresponding to folder one by one is prepared, and setting of write permit or write prohibit may be determined in this table. Or by preparing a folder name list for determine write permit or write prohibit preliminarily, it may be judged by determining whether or not to coincide with this table. It may be judged by other proper method.

At step p4, if the write destination is a prohibited folder, returning to step p3, extraordinary process is executed. If the prohibit mechanism is invalid at step p1, the file is created as usual (step p5), and the process is terminated.

By this operation, if write rejection is set by the key switch 25, creation of executable file or creation into prohibited folder can be eliminated. When set in write permission, it is allowed to create as usual.

Referring now to the process flow in FIG. 6, the write control process for open executed by the control unit 11 according to the write control software 34 is explained.

When the prohibit mechanism is valid, that is, when the key switch 25 is set at the write reject side (step s1), it is judged whether the write command is for open or not (step s2).

If it is for open, it is judged whether the write command object file is executable or not (step s3).

In the case of judging an executable file, it is an extraordinary process, and open process is not executed, and an error is set (step s4). Instead of setting an error, the execution attribute may be turned off, and it may be opened as nonexecutable attribute. Or saving position of file name or file may be changed at will. Thus, at step s4, any other process than the request from the application 31 and OS 32 can be executed freely.

At step s3, when the file is not executable, it is judged whether the write destination is prohibited folder or not (step s5).

In the case of a prohibited folder, returning to step s4, extraordinary process is executed. If it is not prohibited folder, the prohibit mechanism is invalid at step s1, or it is open for reading at step s2, the file is opened as usual (step s6), and the process is terminated.

By this operation, if write rejection is set by the key switch 25, opening of executable file or opening of prohibited folder can be eliminated. When set in write permission, the file can be opened as usual.

Referring to the process flow in FIG. 7, the write control process for attribute change executed by the control unit 11 according to the write control software 34 is explained.

When the prohibit mechanism is valid, that is, when the key switch 25 is set at the write reject side (step r1), it is judged whether the attribute specified by the write command is executable or not (step r2).

In the case of judging the specified attribute to be executable, it is an extraordinary process, and attribute change process (to change and update attribute) is not executed, and an error is set (step r3). Instead of setting an error, the saving position of file name or file may be changed at will. Thus, at step r3, any other process than the request from the application 31 and OS 32 can be executed freely.

At step r2, when the specified attribute is not executable, it is judged whether the write destination is prohibited folder or not (step r4).

In the case of a prohibited folder, returning to step r3, extraordinary process is executed. If it is not prohibited file or the prohibit mechanism is invalid at step r1, the attribute is changed as usual (step r5), and the process is terminated.

By this operation, if write rejection is set by the key switch 25, change of file attribute to executable type or attribute change of file in prohibited folder can be eliminated. When set in write permission, the attribute is changed as usual.

Referring to the process flow in FIG. 8, the write control process for delete executed by the control unit 11 according to the write control software 34 is explained.

When the prohibit mechanism is valid, that is, when the key switch 25 is set at the write reject side (step u1), it is judged whether the attribute of file specified by the write command is executable or not (step u2).

In the case of executable type, it is an extraordinary process, and delete process is not executed, and an error is set (step u3). Instead of setting an error, the saving position of file name, execution attribute or file may be changed at will. Thus, at step u3, any other process than the request from the application 31 and OS 32 can be executed freely.

At step u2, when the specified attribute is not executable, it is judged whether the delete destination is prohibited folder or not (step u4).

In the case of a prohibited folder, returning to step u3, extraordinary process is executed. If it is not prohibited file or the prohibit mechanism is invalid at step u1, the file is deleted as usual (step u5), and the process is terminated.

By this operation, if write rejection is set by the key switch 25, deletion of executable file or deletion of file in prohibited folder can be eliminated. When set in write permission, the file is deleted as usual.

According to the embodiment as described herein, write permission or rejection of file into the storage device 37 can be physically changed over by the key switch 25. Since writing of all executable files such as programs can be rejected, creation of execution file by computer virus or creation of execution file by unjust access can be securely eliminated by setting of key switch 25.

When installing the application software or writing execution file, the user turns the key switch 25 to change over to the write permit side, and can write easily.

Thus, since the write permit time is very short, the risk of file writing by unjust access or computer virus is very low. As required, during write permit time, by physically removing the LAN cable or physically disconnecting from the network, the security is further heightened.

When reading, by allowing to pass directly, file reference and other operation can be executed as usual.

Unlike the prior art of managing by the ID and password, there is no threat of loss of security due to leak of ID and password once the management authority is removed due to presence of security hole or the like, and unauthorized writing can be rejected securely.

In the embodiment explained above, write rejection is set when the write rejection is set by the key switch 25 and the executable file is writing into prohibited folder, but as far as the key switch 25 is set in write rejection, it may be set to reject writing regardless of the type of file.

In this case, alteration of data file by unjust access can be also prevented.

In this embodiment, the key switch 25 is incorporated in the casing 10, but it may be also provided externally by USB connection or RS-232C connection.

Instead of the key switch 25, write permission or rejection may be changed over by checking if a detachable recording medium (for example, flexible disk, CD-ROM, nonvolatile memory, etc.) is inserted in the drive or not. For example, as shown in the perspective view in FIG. 9, when the flexible disk 14a is inserted in the FD drive 14, the switch is turned on, and when not inserted, the switch is turned off. By setting either one of ON and OFF as write permission and other as write rejection, writing can be controlled by the same process as in the case of the key switch 25.

Also instead of the key switch 25, write permission or rejection may be changed over by checking if USB terminal of other device is connected or not to the connection interface with other device. For example, as shown in the perspective view in FIG. 10 (A) and front partial magnified view in (B), when the USB device 16a is connected to the USB interface 16, the switch is turned on, and when not connected, the switch is turned off. By setting either one of ON and OFF as write permission and other as write rejection, writing can be controlled by the same process as in the case of the key switch 25.

Instead of the key switch 25, write permission or rejection may be changed over by software switch. In this case, as shown in perspective view in FIG. 11, a setting screen is shown in the display 21.

On the setting screen, write valid or write invalid is selected and permitted by radio button. When the setting button is pressed while either is selected, this state is determined, or when interrupt button is pressed, the process is interrupted.

Write valid is setting to validate write command to permit writing into the storage device 37. Write invalid is setting to control writing by the process in FIG. 4 to FIG. 8 described above.

As the software switch, as shown in perspective view in FIG. 12, it may be designed to set by the password input screen. In this case, by entering the password and pressing the setting button, writing is permitted. When the interrupt button is pressed after entering the password, writing is rejected.

Therefore, by setting in write rejection usually, writing is controlled in the process shown in FIG. 4 to FIG. 8, and when installing the application, it may be interrupted to permit to write.

Also as the software switch, as shown in perspective view in FIG. 13, it may be designed to display a write request confirm screen in the event of write request. In this case, when the permit button is pressed, writing is permitted. If prohibit button is pressed, it is judged that writing is rejected, and writing is controlled in the process shown in FIG. 4 to FIG. 8.

Thus, the user can judge whenever write request occurs.

Also as the software switch, as shown in perspective view in FIG. 14, it may be designed to display a password input screen in the event of write request. In this case, when the password is entered and the setting button is pressed, writing is permitted. If a wrong password is entered or the interrupt button is pressed, it is judged that writing is rejected, and writing is controlled in the process shown in FIG. 4 to FIG. 8.

Thus, the user can judge whenever write request occurs.

It may be also configured to judge the access to the storage device 37 of the computer system 1 whether direct access by the computer system 1 or remote access by the computer system 1 at a remote place connected to the network by way of the communication system 22.

In this case, it is designed to execute steps n1, n6, n7, n10 in FIG. 4, and when it is judged at step n6 that it is not attribute change request, the process may jump to step n10.

In the write control process for attribute change, the process shown in the processing flow in FIG. 15 may be executed.

That is, if the prohibit mechanism is valid (the key switch 25 is set at write reject side) (step w1), the attribute specified by write command is judged to be attribute of whether write permit or write reject (step w2).

When the specified attribute is judged to be write rejection, as extraordinary process, the attribute change (to change and update attribute) is not executed, and an error is set (step w3). Instead of setting an error, the saving position of file name or file may be changed at will. Thus, at step w3, any other process than the request from the application 31 and OS 32 can be executed freely.

At step w2, when the specified attribute is write permission, the file is changed in the attribute as usual (step w4), and the process is terminated.

By this operation, if write rejection is set by the key switch 25, change of file attribute by remote access can be prevented.

In the key switch 25, the display of write rejection shown in FIG. 1 may be changed to attribute change rejection, and the display of write valid may be changed to attribute change valid.

When the key switch 25 is realized by such software, the screen display shown in FIG. 11 to FIG. 14 may be changed.

More specifically, in the setting screen shown in FIG. 11, the display of write valid of the radio button is changed to attribute change valid, and the display of write valid to attribute change valid.

In the password input screen shown in FIG. 12, the display of write validation is changed to attribute change validation.

In the write request confirm screen shown in FIG. 13, the screen of write request occurrence is changed to attribute change occurrence.

In the password input screen shown in FIG. 14, the display of “Write request has occurred. Enter password if permitting to write” is changed to “Attribute change request has occurred. Enter password if permitting.”

Not limited to attribute change, in the case of remote access, writing is controlled by executing the process in FIG. 4 to FIG. 8, and in the case of direct access, it may be designed to permit writing.

In this case, not judging whether executable and/or prohibited folder, write may be rejected automatically in the case of remote access.

Thus, alteration of file by unjust access from remote place by a third party can be prevented.

In the correspondence between the configuration of the invention and the above embodiment,
the control means of the invention corresponds to the control unit 11 of the embodiment, and similarly thereafter,
the storage means, to the hard disk 23, FD drive 14, and flexible disk,
the switch, to the key switch 25,
the write control means, to the key switch 25 and write control software 34,
the operating system, to the OS 32, and
the write control program, to the write control software 34,
but it must be noted that the invention is not limited to the illustrated embodiment alone, but may be changed in modified in various embodiments.

### INDUSTRIAL APPLICABILITY

The present invention can be applied in personal computer, server, PDA, mobile phone, other portable information terminal, and other computer system.

### BRIEF DESCRIPTION OF THE DRAWINGS

FIG. 1 is a perspective view of outline configuration of computer system.

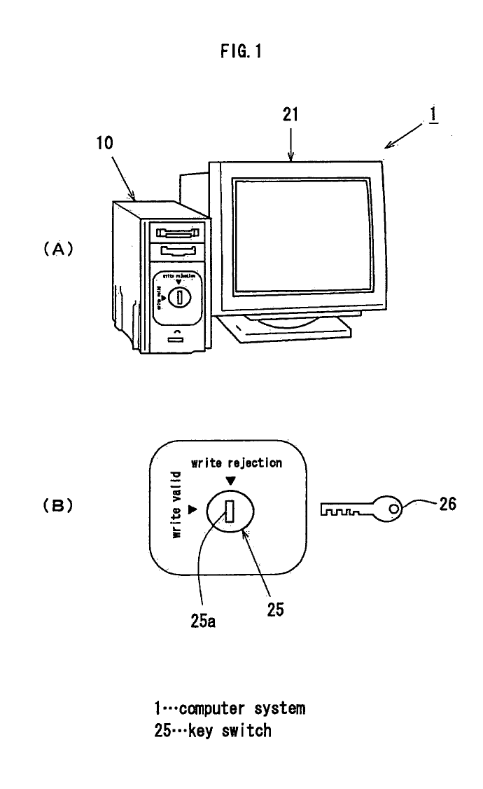

FIG. 2 is a block diagram of configuration of computer system.

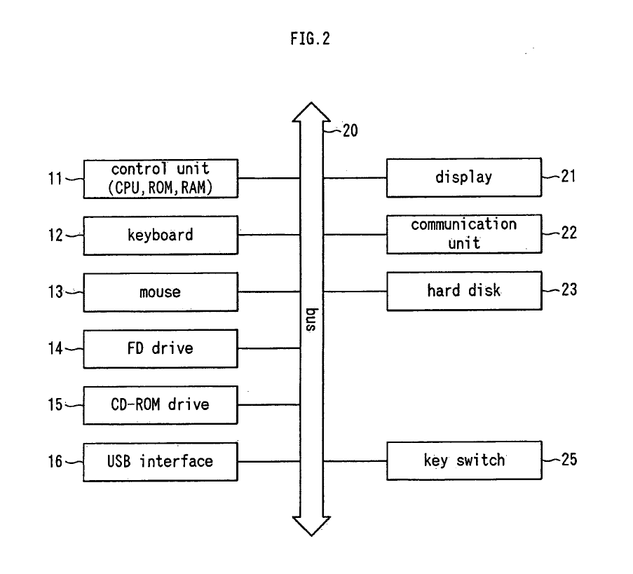

FIG. 3 is a conceptual diagram of configuration of software relating to writing into storage device.

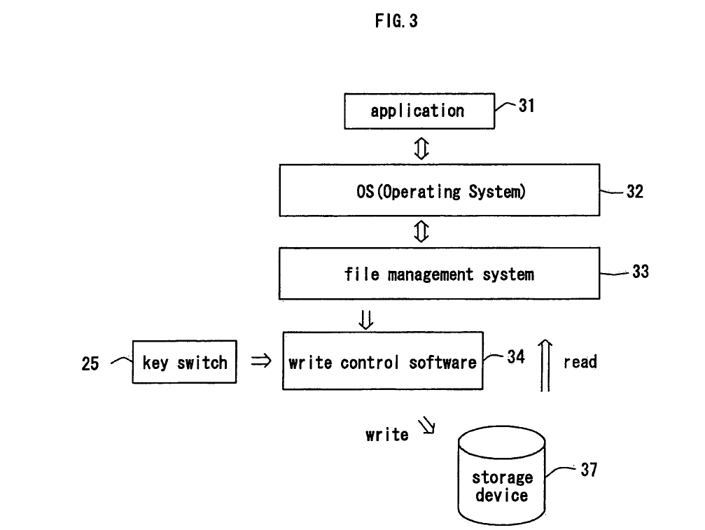

FIG. 4 is a processing flowchart showing entire process of file management process.

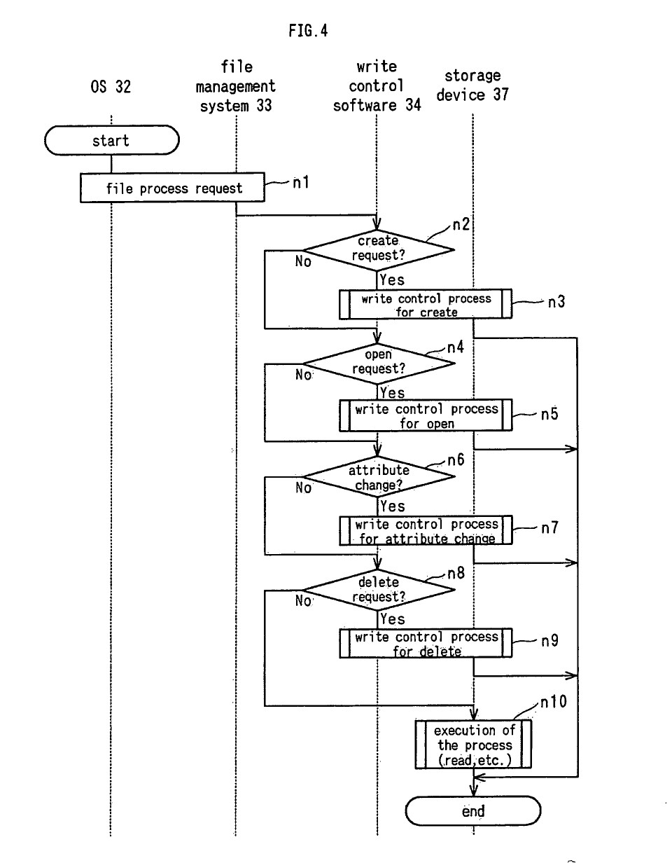

FIG. 5 is a processing flowchart of write control process for create.

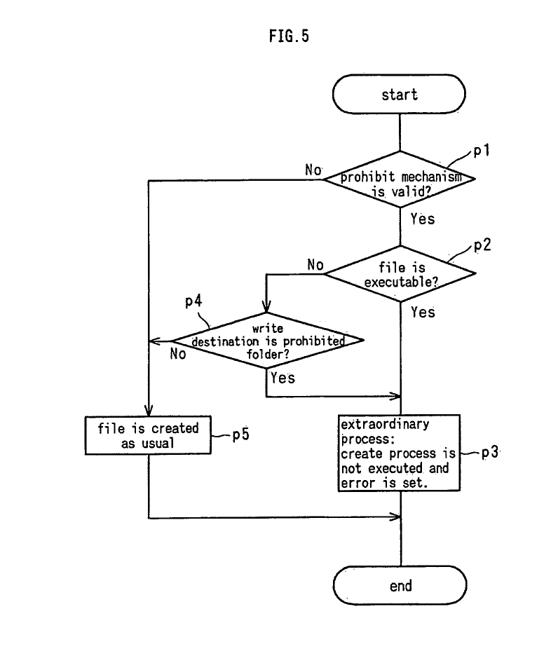

FIG. 6 is a processing flowchart of write control process for open.

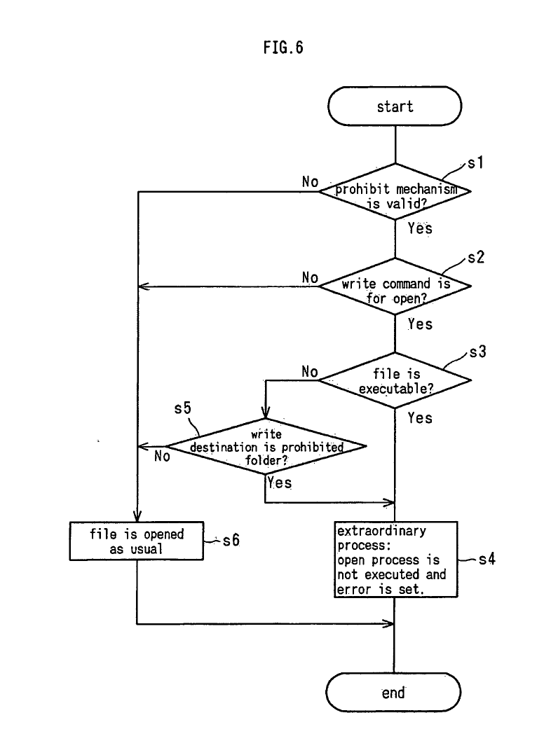

FIG. 7 is a processing flowchart of write control process for attribute change.

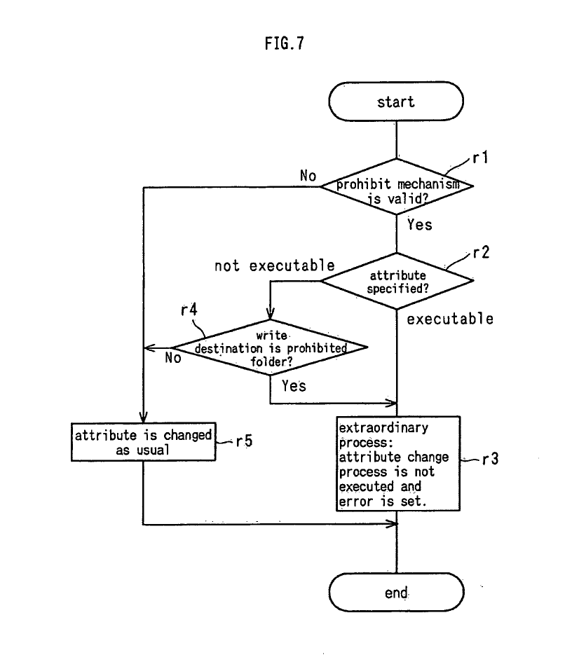

FIG. 8 is a processing flowchart of write control process for delete.

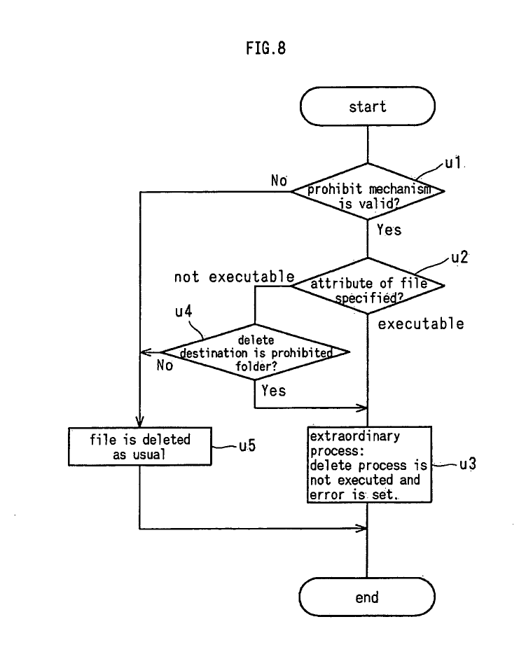

FIG. 9 is a perspective view of outline configuration of FD changeover type.

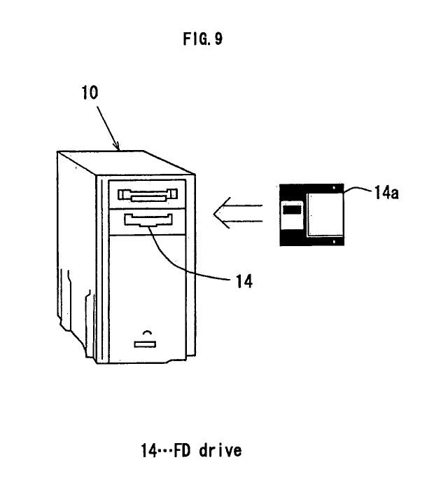

FIG. 10 is a perspective view of outline configuration of USB changeover type.

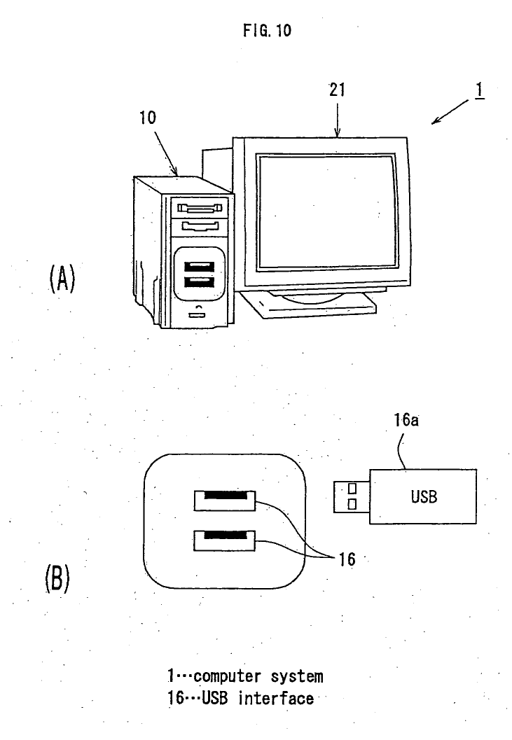

FIG. 11 is a perspective view of outline configuration of software changeover type by setting screen.

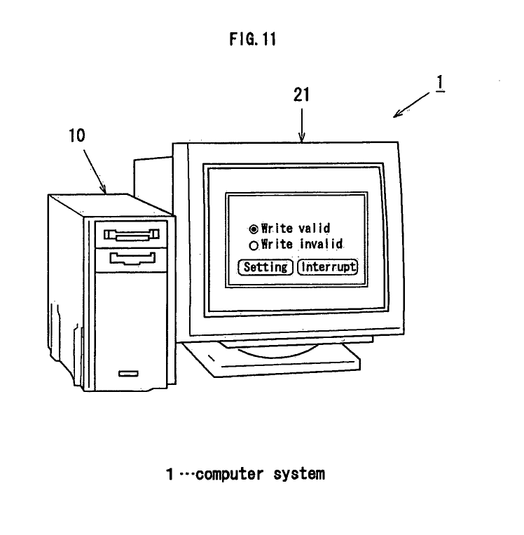

FIG. 12 is a perspective view of outline configuration of software changeover type by password input screen.

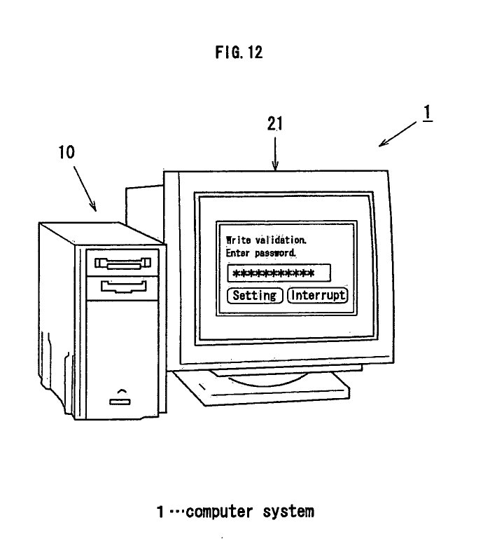

FIG. 13 is a perspective view of outline configuration of software changeover type by write request confirm screen.

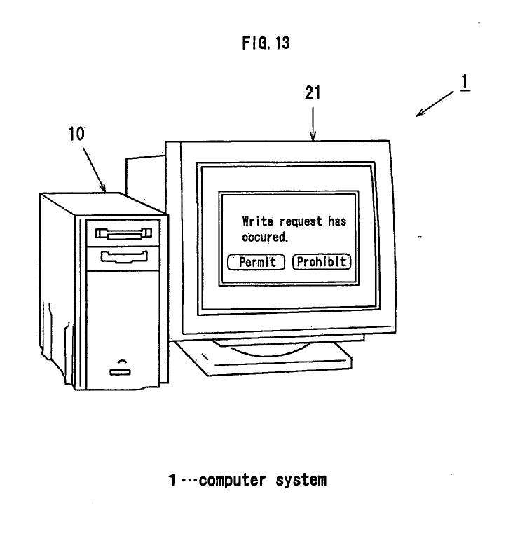

FIG. 14 is a perspective view of outline configuration of software changeover type by password input screen.

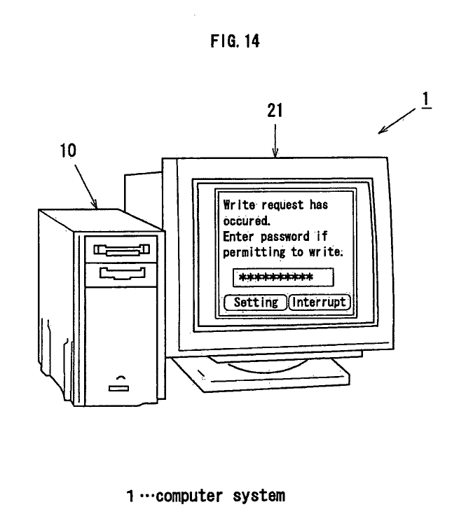

FIG. 15 is a process flowchart of write control process for attribute change in other embodiment.

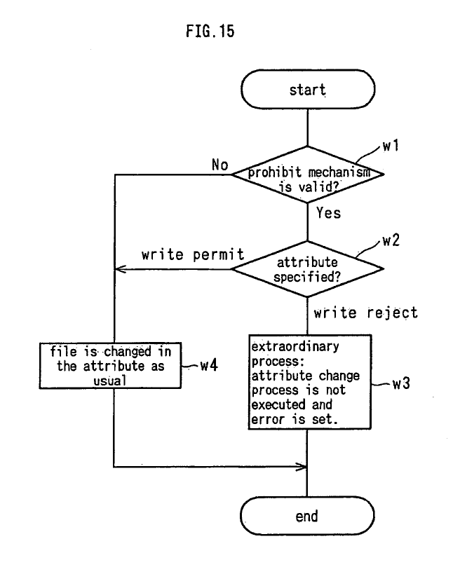

### DESCRIPTION OF THE REFERENCE NUMERALS AND SIGNS

1 Computer system
11 Control unit
14 FD drive
23 Hard disk
25 Key switch
32 OS
33 File management system
34 Write control software

1. A write control method, being a write control method for controlling writing of file into storage means by making use of file management system by an operation system as basic software of computer system, by control means for executing various control processes in a computer system,
wherein write control means changes over permission or rejection of writing into the storage means on the basis of changeover input by a user, and
transmits to the storage means by way of the write control means when transmitting a write command to the storage means in the file management system.

2. The write control method of claim 1,
wherein the write control means is provided with a switch, and permission or rejection of writing can be physically changed over by this switch .

3. The write control method of claim 1,
wherein when permitting writing by the write control means, the write command is passed, and
when rejecting writing, the write command is blocked.

4. The write control method of claim 1,
wherein the write control means rejects writing when the user has changed over to reject writing by input of changeover and the file of write command is a file of write rejected type, and
permits writing otherwise.

5. The write control method of claim 1,
wherein the write control means rejects writing when the user has changed over to reject writing by input of changeover and the folder holding the file according to the write command has been set in write rejection, and
permits writing otherwise.

6. A computer system comprising:
control means for executing various control processes,
storing means for storing a file,
the control means executing writing of file into the storing means by making use of file management system by an operation system as basic software, and
write control means for controlling changeover of write permission or rejection into the memory means on the basis of changeover input by a user,
wherein the file management system is set to transmit to the storing means by way of the write control means when transmitting the write command to the storing means.

7. The computer system of claim 6,
wherein the write control means is composed of a switch for changing over write permission or rejection physically.

8. The computer system of claim 6,
wherein the write control means is composed as follows:
when permitting writing by the write control means, the write command is passed, and
when rejecting writing, the write command is blocked.

9. The computer system of claim 6,
wherein the write control means is composed as follows:
writing is rejected when the user has changed over to reject writing by input of changeover and the file of write command is a file of write rejected type, and
writing is permitted otherwise.

10. The computer system of claim 6,
wherein the write control means is composed as follows:
writing is rejected when the user has changed over to reject writing by input of changeover and the folder holding the file according to the write command has been set in write rejection, and
writing is permitted otherwise.

11. A write control program for executing the write control method as set forth in claim 1.

12. An operating system incorporating the write control program of claim 11.
